(19) United States
(12) Patent Application Publication
(10) Pub. No.: US 2005/0006851 A1
(43) Pub. Date: Jan. 13, 2005

(54) Brush seal with windage control

(76) Inventor: Mark E. Addis, Kennebunk, ME (US)

Correspondence Address: PRATT & WHITNEY, 400 MAIN STREET, MAIL STOP: 132-13, EAST HARTFORD, CT, 06108, US

(21) Appl. No.: 10/616,028

(22) Filed: Jul. 9, 2003

(51) Int. Cl. F16J 15/44

(52) U.S. Cl. 277/355

(57) ABSTRACT

A brush seal with: a back plate; a side plate; a first set of bristles; and a second set of bristles between the first set of bristles and the side plate, The second set of bristles have a characteristic, different than the first set of bristles, that reduces windage effects on the first set of bristles. A brush seal for sealing a gap between first and second components, having: a back plate; a side plate; a set of contacting bristles that engages the second component; and a set of non-contacting bristles that extends towards, but does not engage, the second component. The non-contacting bristles reside between the contacting bristles and the side plate. In a brush seal having a set of longer bristles adjacent a set of shorter bristles, wherein the improvement comprises the shorter bristles located on a high pressure side of the longer bristles.

### BACKGROUND OF THE INVENTION

This invention relates to brush seals. Specifically, the present invention relates to brush seal that have features to control windage.

Brush seals prevent fluid flow through a gap between two components. The brush seal typically secures to the first component and has a pack of wire bristles that span the gap between the two components. The density of the bristle pack prevents leakage of the fluid through the gap.

Windage, however, can detrimentally affect such conventional brush seal designs. Windage can lift, twist and bend the bristles. Over time, these forces cold work the bristles. Eventually, the bristles flare (also referred to as mushrooming or brooming). Flared bristles no longer make contact with the second component. This leaves fewer bristles to contact the second component. Fewer bristles contacting the second component decrease the effective thickness of the seal area. In other words, the flared bristles essentially become useless since they no longer prevent fluid leakage through the gap. This reduces the effectiveness of the brush seal.

Windage typically affects the bristles located at the high pressure side of the seal rather than at the low pressure side of the seal. Accordingly, mushrooming tends to occur with bristles on the high pressure side of the brush seal. The high pressure side has a greater tendency for mushrooming because these bristles have a greater free length exposed to windage. In fact brush seals (without an integral windage cover) expose the entire free length of bristles on the high pressure side to windage. By comparison, bristles on the low pressure side of the seal receive upstream support from, and protection from direct exposure to windage by, the high pressure side bristles. The low pressure side bristles also receive downstream support (along a substantial majority of bristle length) from the back plate.

Another reason for the tendency for the high pressure side of the brush seal to mushroom is the level of windage on the high pressure side. Windage abates from the high pressure side to the low pressure side of the brush seal as the flow passes through the bristle packs.

Even with windage covers, bristles on the high pressure side still have exposure to windage and thus mushroom. Typically, a windage cover is a flange extending from the side plate towards the second component. Since the windage cover must remain a distance away from the second component (to prevent contact with the second component during an excursion event), the high pressure side bristles still have a greater free length exposed to windage than the low pressure side bristles.

### BRIEF SUMMARY OF THE INVENTION

It is an object of the present invention to provide an improved brush seal.

It is a further object of the present invention to provide a brush seal with windage control.

It is a further object of the present invention to provide a brush seal that inhibits bristle flare in response to windage effects.

It is a further object of the present invention to provide a brush seal that controls windage effects without risking damage to other components during an excursion event.

It is a further object of the present invention to provide a brush seal that maintains an effective seal length despite windage effects.

These and other objects of the present invention are achieved in one aspect by a brush seal, comprising: a back plate; a side plate; a first set of bristles; and a second set of bristles between the first set of bristles and the side plate. The second set of bristles have a characteristic, different than the first set of bristles, that reduces windage effects on the first set of bristles.

These and other objects of the present invention are achieved in another aspect by a brush seal for sealing a gap between first and second components, comprising: a back plate; a side plate; a set of contacting bristles that engages the second component; and a set of non-contacting bristles that extends towards, but does not engage, the second component. The set of non-contacting bristles resides between the set of contacting bristles and said side plate.

These and other objects of the present invention are achieved in another aspect by a brush seal having a set of longer bristles adjacent a set of shorter bristles. The shorter bristles are located on a high pressure side of said longer bristles.

### BRIEF DESCRIPTION OF THE DRAWINGS

Other uses and advantages of the present invention will become apparent to those skilled in the art upon reference to the specification and the drawings, in which:

FIG. 1 is a cross-sectional view of a brush seal of the present invention;

FIG. 2 is a cross-sectional, perspective view, in partial cut-away, of the brush seal of FIG. 1; and

FIG. 3 is an elevational view of the brush seal of FIG. 1.

### DETAILED DESCRIPTION OF THE INVENTION

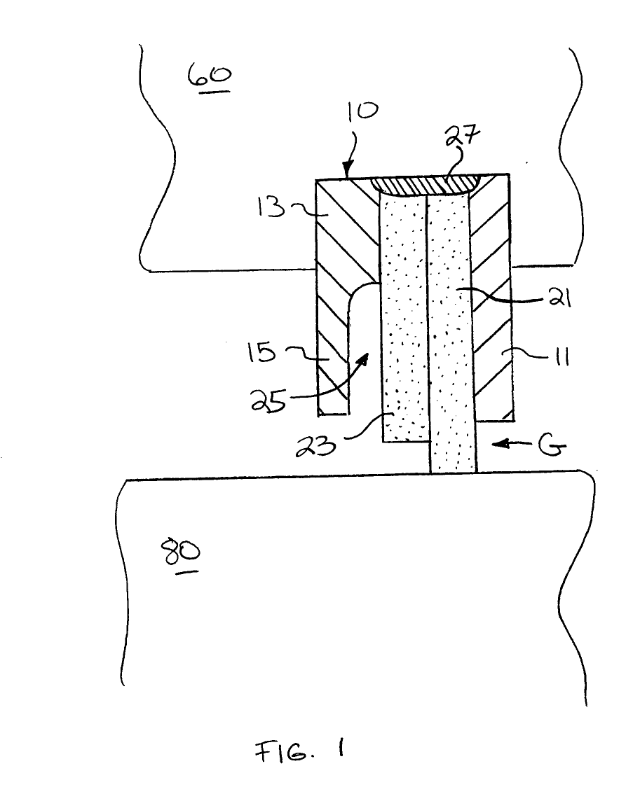

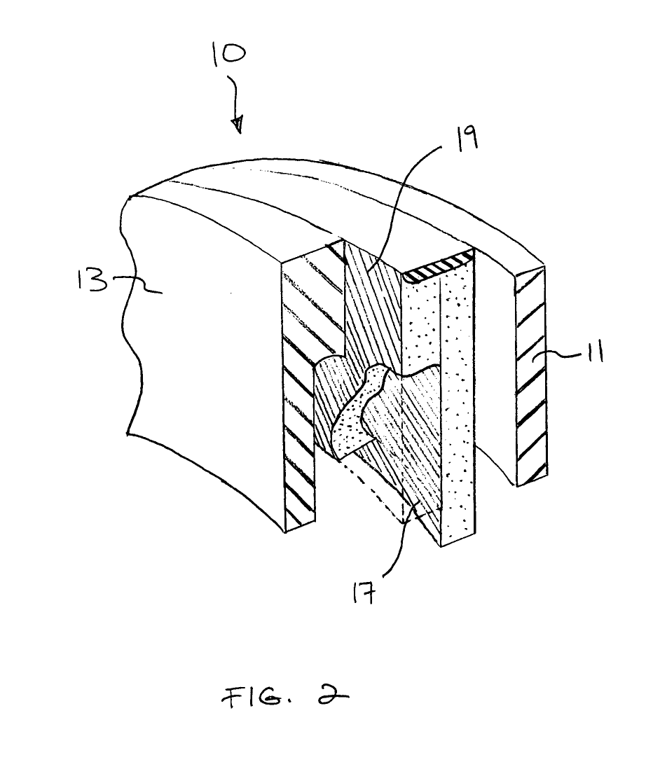

FIGS. 1-3 display one alternative embodiment of a brush seal 10 of the present invention. Although shown as a single stage, the brush seal 10 could have multiple stages. The brush seal 10 secures to a first component 60, such as a stationary component (e.g. a diffuser case) of a gas turbine engine, in conventional fashion and extends towards a second component 80, such as a rotating component (e.g. a rotor) of a gas turbine engine. The brush seal prevents fluid flow through a gap G between the components 60, 80 from a side at a high pressure location (the left side of FIG. 1) to a side at a low pressure location (the right side of FIG. 1).

The brush seal 10 includes a back plate 11 and side plate 13 made from suitable materials. The side plate 13 also preferably includes a windage cover 15. The windage cover 15 is preferably integral with the side plate 13, formed by undercutting the side plate 13. The windage cover extends from the side plate 13 towards the second component 80 add provides protection from windage.

The brush seal 10 also includes a first set of densely arranged bristles 17 and a second set of densely arranged bristles 19. The bristles 17, 19 are made from a suitable material, such as a cobalt alloy wire. The sets of bristles 17, 19 define bristle packs 21, 23. The bristle packs 21, 23 reside between the plates 11, 13.

The first bristle pack 21 serves the typical purpose of a bristle pack. Namely, the first bristle pack 21 contacts the second component 80 and prevents fluid leakage through the gap G between the components 60, 80.

The second bristle pack 23 serves a different purpose than the first bristle pack 21. Specifically, the second bristle pack 23 helps the first bristle pack 21 counter the effects of windage. As discussed above, bristles located on the high pressure side of conventional brush seals receive no axial support radially inward of side plate 13. The second bristle pack 23 of the present invention provides such support.

As seen in FIG. 1, the second bristle pack 23 preferably resides between the side plate 13 and the first bristle pack 21. That location allows the first bristle pack 21 to receive axial support along a greater length than with conventional brush seal arrangements. By reducing the unsupported length of the first bristle pack 21, the second bristle pack 23 increases the rigidity of the first bristle pack 21. The increased rigidity helps the first bristle pack 21 better withstand windage effects than conventional brush seals. The second bristle pack 23 also protects the first bristle pack 21 from direct exposure to windage.

While supporting the first bristle pack 21 and sheltering the first bristle pack 21 from windage, the second bristle pack 23 should avoid interfering with the operation of the first bristle pack 21. In other words, the second bristle pack 23 should not impede the ability of the first bristle pack, for example, to engage the rotating component 80 and to react to rotor excursions.

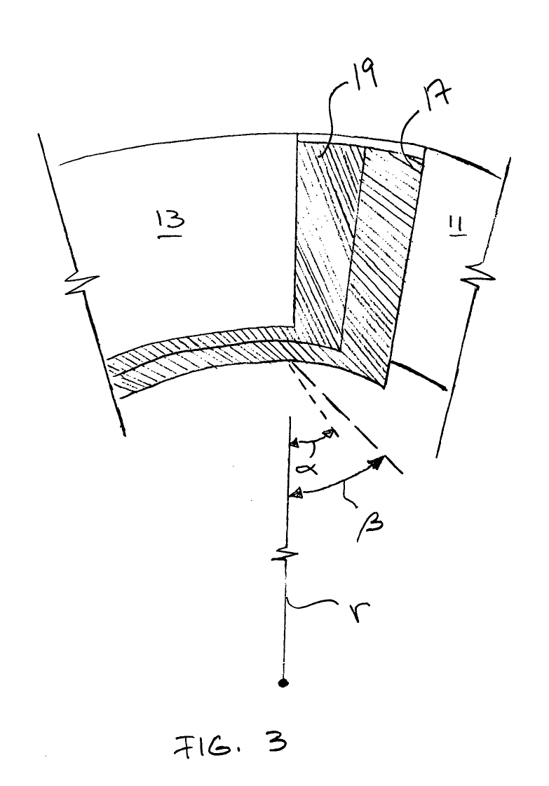

One manner of preventing interactions between the bristles of the different bristle packs 21, 23, is to use different lay angles. As seen in FIG. 3, the bristles 19 in the second bristle pack 23 lay at an angle a relative to a radial line r. The bristles 17 of the first bristle pack 21 lay at an angle β relative to the radial line r. The specific values for the angles α, β are not important to the present invention. However, the difference between the angles α, β is important to the present invention. The difference between the angles α, β preferably ranges between 0° and ±15°.

Another manner of preventing interactions between the bristles of the different bristle packs 21, 23, is to introduce shims (not shown) between the bristle packs 21, 23. Shims may be required around the circumference of the interface between the bristle packs 21, 23, for example, if the size of an undercut 25 (formed when machining the side plate 13) does not allow the second bristle pack 23 to flare unencumbered. The space produced by the shims provides additional space for the second bristle pack 23 to flare.

To ensure adequate support by the second bristle pack 23 to the first bristle pack 21, the second bristle pack 23 can be more rigid than the first bristle pack 21. The severity of the windage would determine the specific rigidity required from the second bristle pack. The primary method of increasing the rigidity of the second bristle pack 23 is to shorten the bristles 19. As seen in FIG. 1, the length of the bristles 19 is such that the second bristle pack 23 does not contact the second component 60. To ensure sufficient windage protection, however, the second bristle pack 23 should cover as much of the length of the first bristle pack 21 as possible. At a minimum, the second bristle pack 23 should extend (in a radially inward direction) to the back plate 11. At this position, the second bristle pack 23 would not contact the second component 60 under any operating condition.

A secondary method of increasing the rigidity of the second bristle pack 23 is to utilize larger diameter wires in the second bristle pack 23 than with the first bristle pack 21. For instance, bristle packs 21, 23 with the same lay angle (i.e. a 0° difference between angles α, β) could use 0.006″ diameter wires for bristles 19 while the first bristle pack 21 could use 0.0028″ diameter wires for bristles 17. The use of different diameter wire has the additional benefit of preventing interaction between the bristle packs 21, 23. As the lay angles of the bristle packs 21, 23 diverge (i.e. the difference between angles α, β approaches ±15°), the benefit of using different diameter wire to prevent interaction becomes less pronounced.

The brush seal 10 could be assembled as follows. The operator first places the back plate 11 within a suitable fixture (not shown). The operator then places tufts (not shown) of bristles 17 on the back plate 11. The operator welds the tufts of bristles 17 to the back plate 11. Now secured to the back plate 11, the tufts of bristles 17 form the first bristle pack 21.

Next, the operator places the side plate 13 within a suitable fixture (not shown). The operator then places tufts (not shown) of bristles 19 on the side plate 13. The operator welds the tufts of bristles 19 to the side plate 13. As with the first bristle pack 21, the tufts of bristles 19 now secured to the side plate 13 form the second bristle pack 23.

As an alternative to tufts of bristles 17, 19, the bristle packs 21, 23 could be pre-assembled as described in more detail in U.S. Patent application Ser. No. 10/074,191 filed on 12 Feb. 2002 and herein incorporated by reference. Briefly summarizing the disclosure, a bristle pack is pre-assembled by securing the bristles together, in advance, by a weld joint. The pre-assembled bristle pack resembles a ring.

The operator then places the side plate 13 (with the attached second bristle pack 23) on the back plate 11 (with the attached first bristle pack 21) in a fixture (not shown) to sandwich the components together. The operator then welds the plates 11, 13 together along the outer diameter, forming a weld joint 27. Finally, the operator removes the brush seal 10 from the fixture. As described earlier, the operator could insert a shim between the bristle packs 21, 23 to prevent interaction during brush seal operation.

While the figures show the bristle sets comprising separate bristle packs 21, 23, the present invention contemplates that the bristle sets could be part of a single bristle pack (not shown).

The present invention has been described in connection with the preferred embodiments of the various figures. It is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

1. A brush seal, comprising:
a back plate;
a side plate;
a first set of bristles; and
a second set of bristles between said first set of bristles and said side plate, said second set of bristles having a length and abutting said first set of bristles substantially along said length;
wherein said first set of bristles extending further from the brush seal than said second set of bristles said side plate to reduces windage effects on said first set of bristles.

2. The brush seal of claim 1, wherein said second set of bristles are more rigid than said first set of bristles.

3. The brush seal of claim 2, wherein bristles in said second set have a larger diameter than bristles in said first set.

4. (Cancelled)

5. The brush seal of claim 1, wherein said sets of bristles have non-interfering lay angles.

6. The brush seal of claim 2, wherein said first and second sets of bristles have first and second lay angles, respectively, and a difference between said first and second lay angles is between approximately −15° and 15°.

7. (Cancelled)

8. The brush seal of claim 1, wherein said second set of bristles extends at least to said back plate.

9. The brush seal of claim 1, wherein said first and second sets of bristles comprise separate bristle packs.

10. The brush seal of claim 1, further comprising a windage cover.

11. A brush seal for sealing a gap between first and second components, comprising:
a back plate;
a side plate;
a set of contacting bristles that engages the second component; and
a set of non-contacting bristles that extends towards, but does not engage, the second component, said set of non-contacting bristles having a length;
wherein said set of non-contacting bristles resides between said set of contacting bristles and said side plate and abuts said set of contacting bristles substantially along said length.

12. The brush seal of claim 11, wherein said sets of bristles have non-interfering lay angles.

13. The brush seal of claim 12, wherein said sets of bristles have first and second lay angles, respectively, and a difference between said first and second lay angles is between approximately −15° and 15°.

14. The brush seal of claim 11, wherein said set of non-contacting bristles is more rigid than said set of contacting bristles.

15. The brush seal of claim 14, wherein bristles in said set of non-contacting bristles have a diameter larger than bristles in said set of contacting bristles.

16. The brush seal of claim 11, further comprising a windage cover.

17. The brush seat of claim 11, wherein said set of contacting bristles and said set of non-contacting bristles comprise separate bristle packs.

18. The brush seal of claim 11, wherein said non-contacting bristles extends at least to said back plate.

19. (Cancelled)

20. A method of making a brush seal, comprising the steps of:
providing a back plate, a side plate, a first set of bristles, and a second set of bristles having a length less than said first set of bristles; and
abutting said first set of bristles substantially along said length;
wherein said first set of bristles extends further from the brush seal than said second set of bristles to reduce windage effects on said first set of bristles.

21. The method of claim 20, wherein said second set of bristles are more rigid than said first set of bristles.

22. The method of claim 21, wherein bristles in said second set have a larger diameter than bristles in said first set.

23. The method of claim 20, wherein said sets of bristles have non-interfering lay angles.

24. The method of claim 23, wherein said first and second sets of bristles have first and second lay angles, respectively, and a difference between said first and second lay angles is between approximately −15° and 15°.

25. The method of claim 20, wherein said second set of bristles extends at least to said back plate.

26. The method of claim 20, wherein said first and second sets of bristles comprise separate bristle packs.

27. The method of claim 20, wherein the providing step includes providing a windage cover.
